(19) United States
(12) Patent Application Publication
(10) Pub. No.: US 2009/0183266 A1
(43) Pub. Date: Jul. 16, 2009

(54) METHOD AND A SYSTEM FOR RECOVERING A LOST OR STOLEN ELECTRONIC DEVICE

(76) Inventors: Lek Han Tan, Singapore (SG); Huat Chye Gerard Lim, Singapore (SG)

Correspondence Address: FAY KAPLUN & MARCIN, LLP, 150 BROADWAY, SUITE 702, NEW YORK, NY, 10038, US

(21) Appl. No.: 12/170,637

(22) Filed: Jul. 10, 2008

Related U.S. Application Data
(60) Provisional application No. 61/020,401, filed on Jan. 11, 2008.

(51) Int. Cl. G06F 21/00

(52) U.S. Cl. 726/35

(57) ABSTRACT

A method and system for recovering a lost or stolen electronic device is provided. The method includes determining trace information to trace a present user of the electronic device, and obtaining an authentication information to determine whether or not the present user of the electronic device is a valid user of the electronic device. The method further includes sending the trace information to another user who had been previously determined to be the valid user of the electronic device, if it is determined that the present user is not the valid user of the electronic device.

### CROSS-REFERENCES TO RELATED APPLICATIONS

The present application claims the benefit of U.S. provisional application 61/020,401, filed on Jan. 11, 2008, and entitled “System and Method for Recovering a Lost or Stolen Electronic Device”, the entire contents of which are incorporated herein by reference.

### TECHNICAL FIELD

Embodiments of the invention relate to a method for recovering a lost or stolen electronic device, as well as a corresponding system.

### BACKGROUND

The concept of anti-theft is essentially about the recovery of lost or stolen items. The lost or stolen items may be, for example, mobile electronic devices or mobile communication devices, which may be carried and used by a person while moving from one place to another.

Electronic devices may be portable devices which are easily carried. Such electronic devices may include mobile communications devices, such as cell phones and other devices intended to be used for communications, as well as other portable electronic devices, such as personal digital assistants (PDAs), portable media players, portable gaming or entertainment devices, or devices such as laptop computers, for example.

Due to their relatively small size and portability, the above mentioned electronic devices may be misplaced easily while the owner is moving from one place to another. For similar reasons, such electronic devices may be easily stolen.

The loss of such an electronic device may be more costly to the owner than the actual dollar value of the electronic device. For example, the electronic device may contain vital information which the owner depends on for his daily activities. Hence, it would often be more convenient and less costly for the owner to be able to recover his lost electronic device, rather than to replace it.

### SUMMARY OF THE INVENTION

One embodiment of the invention provides a method for recovering a lost or stolen electronic device. The method includes determining trace information to trace a present user of the electronic device, and obtaining authentication information to determine whether or not the present user of the electronic device is a valid user of the electronic device. The method further includes sending the trace information to another user who had been previously determined to be the valid user of the electronic device, if it is determined that the present user is not the valid user of the electronic device.

Another embodiment of the invention provides a system for recovering a lost or stolen electronic device. The system includes a trace unit configured to determine trace information to trace a present user of the electronic device, and an authentication unit configured to obtain authentication information to determine whether or not the present user of the electronic device is a valid user of the electronic device. The system further includes a transmitting unit configured to send the trace information to another user who had been previously determined to be the valid user of the electronic device, if it is determined that the present user is not the valid user of the electronic device.

### BRIEF DESCRIPTION OF THE DRAWINGS

The foregoing and other advantages of the invention will become apparent upon reading the following detailed description and upon reference to the drawings in which:

FIG. 1 shows an illustration of the architecture of an electronic device on which the anti-theft software may be run according to an embodiment of the invention.

FIG. 2 shows an illustration of the architecture of an anti-theft system in accordance to an embodiment of the invention.

FIG. 3 shows a flow diagram illustrating a method for recovering a lost or stolen electronic device according to an embodiment of the invention.

FIG. 4 shows a flow diagram illustrating a first implementation of the method for recovering a lost or stolen electronic device according to an embodiment of the invention.

FIG. 5 shows an illustrative example of numerous display windows for the first module of a first implementation of one embodiment of the invention.

FIG. 6 shows a flow diagram illustrating a second implementation of the method for recovering a lost or stolen electronic device according to an embodiment of the invention.

FIG. 7 shows an illustrative example of display windows for the first module of a second implementation of one embodiment of the invention.

FIG. 8 shows an illustrative example of the operation of the respective first and second modules of the first and second implementations of one embodiment of the invention.

FIG. 9 shows a flow diagram illustrating a server-based method in accordance with an embodiment of the invention.

FIG. 10 shows a block diagram of a system suitable for use with a server-based method, in accordance with an embodiment of the invention.

In the drawings, like reference characters generally refer to the same parts throughout the different views. The drawings are not necessarily to scale, emphasis instead generally being placed upon illustrating the principles of the invention.

### DETAILED DESCRIPTION OF ILLUSTRATIVE EMBODIMENTS

In accordance with an embodiment of the invention, should the electronic device be lost or stolen, several factors may be used to assist in the recovery of the lost or stolen electronic device.

The ownership of an electronic device may be clearly and irrevocably imprinted in the electronic device. In one example, this may involve using a password secured access or a digital lock on the electronic device or on the ownership identification capabilities of an electronic device. Other identification tools which may be used to secure the electronic device include barcode (e.g., the National Registration Identity Card (NRIC) in Singapore), finger print recognition, signature recognition, voice recognition, facial recognition, or other biometric identification means, for example. In some embodiments, only the rightful owner, who created such a password or digital lock, may be able to unlock it or change it. Such a security mechanism may confirm the ownership of the electronic device and may allow only the owner to use the electronic device. In some embodiments, no one but the rightful owner of the device should be able to bypass this security mechanism and access the electronic device.

While the ownership of the electronic device may be secured as mentioned above, ownership by itself may not be sufficient for the recovery of the electronic device, should it be lost or stolen.

The identity of the rightful owner (or valid user) of the electronic device may be important to facilitate anti-theft measures. The valid user's identity may be represented by contact information such as name, phone number, e-mail address, home address, a unique identification number and customizable broadcast text, for example, one or more of which may be stored on the electronic device itself.

As used herein, the term valid user refers to the rightful owner of the electronic device or another person who has been authorized to use the electronic device. The other person who has been authorized to use the electronic device may be, but is not limited to, a member of the rightful owner's family, an employee of the rightful owner, or an agent acting on behalf of the rightful owner, for example.

With the above mentioned contact information, the lost or stolen electronic device may be able to contact the valid user via an available communication service on the electronic device, such as electronic mail (e-mail), Short Messaging Service (SMS), Internet Relay Chat (IRC), messenger service and short-range wireless communications, such as a BLUETOOTH® wireless network, for example. Examples of messenger service include the ICQ messaging system, the MSN® messaging system, the SKYPE® internet telephony and messaging system, and/or the TWITTER messaging system.

In the above scenario, the valid user's contact information may be stored directly in the electronic device.

Alternatively, the valid user's contact information may be stored on a server provided by an anti-theft service provider (who may then contact the valid user), for example. In this case, the electronic device may only have the contact information for the anti-theft service provider and an identity number which may be used to refer to the valid user's contact information stored on the anti-theft service provider's server.

The electronic device which is protected by anti-theft software, for example, may be able to determine whether or not the present user is the valid user. When the electronic device is accessed, or when it is powered up, for example, it may determine whether or not the person about to use the electronic device (or the present user) is a valid user. This determination process may take many forms, depending on the ownership security mechanism implemented.

In one example, if a password login were used to secure the electronic device, then the determination process may involve comparing the password obtained from the present login with the password previously set up by the valid user.

In another example, if the ownership security mechanism were more sophisticated, such as finger print recognition, signature recognition, facial recognition and/or voice recognition, for example, then the technology to implement such a mechanism may be more complicated. In some instances, a difference in the owner information stored in a Subscriber Identity Module (SIM) card from the one originally recorded by the valid user may be sufficient evidence that the present user is not the valid user.

The determination process may occur at any time, as determined by a triggering event. In one embodiment, the triggering event may be the powering up of the electronic device, for example. In another embodiment, the triggering event may be the establishment of a connection with a computer or network, the attempt to access private or confidential data, the determination that a SIM card has been changed, the attempt to change the owner information on the electronic device, and/or the attempt to change access codes or other information used by the electronic device for communication and/or for accessing data sources, for example.

Additionally, if the anti-theft software determines that the present user is not the valid user of the electronic device, then the anti-theft software may gather information that may be useful to help the recovery of the electronic device and then transmit the gathered information to the valid user or to an anti-theft service provider, using the previously recorded contact information. The gathered information may include information relating to the location at which the said electronic device is being used, the context of its usage, the identity of the present (illegitimate) user who may be attempting to use the electronic device, and/or other information which may be useful in recovering the electronic device. The gathered information may be transmitted directly to the valid user, or to an anti-theft service provider who may then contact the valid user.

Further, the gathered information may be transmitted immediately, or at a later time, such as when the electronic device is connected to a communication network, for example. In the case of electronic devices which may not be able to connect directly to a communication network (such as some mp3 players, for example), the transmission of the gathered information may occur as soon as the electronic device is connected to a computer which is connected to the communication network, for example.

Additionally, in some embodiments, the transmission of the gathered information may occur in a covert manner, i.e., without informing the present (illegitimate) user and/or without leaving a trace in communication logs, sent message folders, or other locations where communication events are typically recorded or logged. In some embodiments, the communication may occur in an open manner, for example, by informing the present user of the electronic device that the valid user of the device has been informed of the current location of the electronic device, and informing the present (illegitimate) user on how the electronic device may be returned to its valid user, or to the anti-theft service provider (perhaps, for a small reward, for example).

In more detail, the information gathered by the device may include:

1. the electronic device's own unique identification, such as
a. an International Mobile Equipment Identity (IMEI);
b. a Media Access Control (MAC) Address (provided the electronic device has a network card);
c. any other identification of the device, such as a serial number or other identification information;

2. the present (illegitimate) user's identity information, such as
a. the International Mobile Subscriber Identity (IMSI) of the newly inserted SIM card (in the electronic device);
b. a photograph of the present user or his surroundings (provided the electronic device has a camera) (in some embodiments, such a photograph may be taken without informing the present user);
c. a voice or video recording of the present user or his surroundings (provided the device has voice or video recording capabilities) (again, in some embodiments, such recordings may be taken without informing the present user);

3. the current location where the electronic device is being used, such as
a. Global Positioning System (GPS) coordinates (provided the electronic device has GPS capability);
b. an Internet Protocol (IP) address or information on nearby wireless access points;
c. a radio network cell code, a radio network area code, local base station information or tower information, for example; and/or
d. triangulated location information derived from one or more of the above mentioned types of location information.

The electronic device may then send one or more of the above gathered information items to the valid user (using one or more of the previously recorded owner contact information) or to the anti-theft service provider. This may be achieved, for example, using one or more of the following means (or services) available to the electronic device, such as:

1. a Short Message Service (SMS);

2. an electronic mail (e-mail) (provided the electronic device has access to such a service);

3. Internet Relay Chat (IRC);

4. a short-range wireless network, such as a BLUTOOTH® wireless network (available for short range interactions between electronic devices);

5. facsimile (fax);

6. via a cellular telephone network; and/or

7. via any other communication network (including a wireless network, a cellular network, or a wired communication network or communication line).

Further, actions may also be taken to provide broadcast information from the lost or stolen electronic devices. For example, such actions could:

1. Identify the electronic device transmitting an alert message. This may be done in order to confirm that the alert message transmitted is a valid alert message from the lost or stolen electronic device, since one or more alert messages may be required to identify the present (illegitimate) user of the electronic device. For example, an SMS may include a mobile phone number of the present (illegitimate) user. As a further example, an e-mail may include an e-mail address of the present (illegitimate) user.

2. Capture the identity of the present (illegitimate) user as well as further evidence of the present (illegitimate) user's usage of the electronic device. Additionally, some form of the present (illegitimate) user's identity and evidence of usage of the electronic device may be captured or recorded for subsequent recovery processes, especially when these processes may involve the legal authorities.

3. Capture the current location of the electronic device. So doing may enable the tracking of the movement of the electronic device, as well as enable the immediate recovery of the electronic device, should the electronic device be in close proximity to the valid user.

In some embodiments, the anti-theft system or software may also be able to prevent the electronic device from further usage (or freeze the electronic device), until the valid user unlocks it. So doing may prevent the electronic device from being used, as well as prevent further (illegal) access to the already stored information on the electronic device.

In some embodiments, the anti-theft system or software may perform a complete wipe of the electronic device. This complete wipe can leave the electronic device in a “newly purchased” state. So doing may prevent the (illegal) access to highly confidential or sensitive information, for example, which may be stored on the electronic device.

In some embodiments, the anti-theft system or software may be secured from being tampered with or removed by the present (illegitimate) user. In this regard, the anti-theft software may further include a self-protection mechanism which only allows the valid user to have full access to it.

In some embodiments, the anti-theft software may be run in a hidden manner. In this context, the anti-theft software may require special predefined or user-defined actions to allow access to it.

In some embodiments, the anti-theft software may restore itself automatically, should it be removed from the electronic device. In some embodiments, the anti-theft software may be automatically downloaded (or pushed) onto the electronic device by the anti-theft service provider, when the electronic device is connected to the communication network. Additionally, access to the anti-theft software may require a verification of the present user's identity, such as a password, a biometric identification, or other verification methods as discussed above, or a combination of such methods, for example.

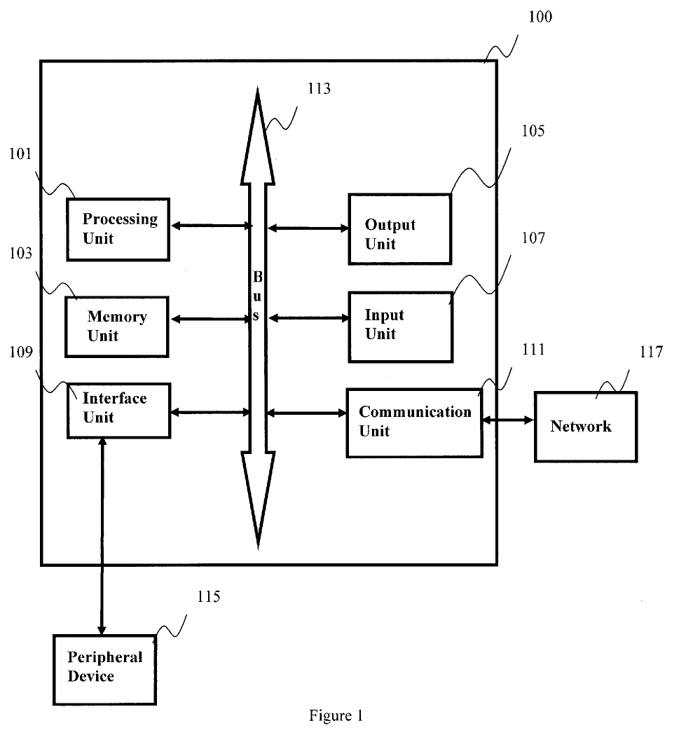

Turning now to the drawings, FIG. 1 shows an example illustration of an architecture of an electronic device 100 on which the anti-theft system or software may be run according to an embodiment of the invention.

In this context, the anti-theft system or software may be an implementation of the method of recovering a lost or stolen electronic device, for example. Further, an electronic device with the anti-theft software in operation may be an implementation of the anti-theft system or an implementation of the system for recovering a lost or stolen electronic device, for example.

The electronic device 100 includes a processing unit 101, a memory unit 103, an output unit 105, an input unit 107, an interface unit 109 and a communication interface unit 111, where each unit is interconnected to other units via a bus 113.

The processing unit 101 may control and interact with other components of the electronic device 100 according to the instruction code provided to it. When provided with suitable instruction code, the processing unit 101 may, for example, control and operate the electronic device 100 to perform one or more steps of the method for recovering a lost or stolen electronic device as described below.

In this context, the processing unit 101 may be, but is not limited to, a combination of one or more general processors, microprocessors, digital signal processors, application specific integrated circuits, field programmable gate arrays, digital circuits and analog circuits, for example. Further, the processing unit may also include a central processing unit (CPU) and/or a graphics processing unit (GPU), or other specialized processing circuitry.

The memory unit 103 may be used to store data. The data stored in the memory unit 103 may be, but is not limited to, input data, data to be processed, intermediate data during the execution of a process, processed data, output data, and instruction codes, for example. In one embodiment, the memory unit 103 may be used to store the information gathered by the electronic device 100, for example.

In this context, the memory unit 103 may be, but is not limited to, a static memory, a dynamic memory, a volatile memory or a non-volatile memory, for example. In more detail, the memory unit 103 may be, but is not limited to, a random access memory, a read-only memory, a programmable read-only memory, an electrically programmable read-only memory, an electrically erasable read-only memory or a flash memory, for example.

Additionally, the memory unit 103 may also be an external data storage device. In this context, the memory unit 103 may be, but is not limited to, magnetic storage media (including a hard-disk or a floppy disc, for example), optical media (including a compact disc (CD) or a digital video disc (DVD, for example), an external flash memory (including a memory stick, for example), a memory card, a memory stick, a universal serial bus (USB) memory device or a SIM card, for example.

In one example, the memory unit 103 may be an internal cache memory or random access memory for the processor unit 101. In another example, the memory unit 103 may be separated from the processor unit 101, such as an external cache memory or a system memory, for example.

The output unit 105 provides an interface for the user to see the functioning of the processor unit 101, or as an interface for interacting with the software stored in the memory unit 103, for example. The output unit 105 may be, but is not limited to, an electronic display unit, such as a liquid crystal display (LCD) unit, an organic light emitting diode (OLED) unit, a flat panel display unit, a solid state display unit, a cathode ray tube (CRT) display unit, a projector unit or a printer (which may provide a hardcopy of the output, such as on paper, for example), for example. Depending on the electronic device, the output unit 105 may further include a variety of outputs, such a sound output, in the form of a headphone connector (e.g., on an MP3 player device) or speaker (e.g., on a cellular phone).

The input unit 107 provides an interface for the user to provide an input while interacting with the software stored in the memory unit 103 or while interacting with one or more other components in the electronic device, for example. The input unit 107 may be, but is not limited to, a number pad, a keyboard, or a cursor control device (such as a mouse or a joystick, for example), a touch screen display unit or a remote control, for example. Depending on the electronic device, the input 107 may also include other kinds of input devices, such as a microphone, a camera, or a biometric device.

The interface unit 109 provides an interface to enable the electronic device 100 to be connected to a peripheral device 115, for example. The interface unit 109 may be, but is not limited to, a Universal Serial Bus (USB), a serial port, or a parallel port, for example.

The peripheral device 115 may be one or more internal devices or external devices. In this context, an internal device refers to a device which may be housed within or together with the electronic device 100 in a same black box, for example. Further, an external device refers to a device which may not be housed together with the electronic device 100. The peripheral device 115 may be, but is not limited to, a flash memory drive, a hard-disk drive, a floppy disk drive or an optical drive, for example. In some embodiments, the peripheral device 115 may include a camera, sound input devices, sound output devices, or biometric devices, depending on the electronic device to which the peripheral device 115 is connected (e.g., many cellular phones include a built-in camera, which may be viewed as either an input device or a peripheral device).

Further, the peripheral device 115 may also include a computer-readable medium, in which one or more sets of instructions, for example, software instructions, may be embedded. The said instructions may perform one or more steps of the method for recovering a lost or stolen electronic device, for example. Additionally, the said instructions may reside completely, or at least partially, within the memory unit 103 and/or within the processor unit 101, during execution.

The communication unit 111 may provide a communication interface for the electronic device 100 to connect to a communication network 117. In this context, the communication unit 111 may provide a wired communication connection or a wireless communication connection to the communication network 117. As such, the communication network 117 may be a wired network, a wireless network or a combination of wired and wireless networks, for example.

For example, the wired network may be, but is not limited to, an Asynchronous Transfer Mode (ATM) network or a Transport Control Protocol/Internet Protocol (TCP/IP) network, for example. The wireless network may be a cellular telephone network (such as a GSM network, a CDMA network, a 3GPP network or an UMTS network, for example), an IEEE 802.11 network, an IEEE 802.16 network, an IEEE 802.20 network, a WI-FI network, a WI-MAX network or a BLUETOOTH® network, for example.

Further, the communication network 117 may be a public network (such as the Internet, for example), a private network (such as an intranet, for example) or combinations thereof. The communication network 117 may also use a variety of networking protocols including, but not limited to, TCP/IP based networking protocols, for example.

In the case where the anti-theft service provider is used, the communication unit 111 may be used to communicate, directly or indirectly, with the anti-theft service provider's server, which may be, but is not limited to, a third party server or an advertising services server, for example.

The electronic device 100 may operate as a standalone device or may be connected (via the interface unit 109 or the communication unit 111, for example) to other computer systems or peripheral devices, for example.

The functions, acts or tasks illustrated in the figures or described herein may be performed by the processor unit 101 being programmed to execute the instructions stored in the memory unit 103, for example. The functions, acts or tasks may be independent of the type of instruction code set, storage media, processor or processing strategy, and may be performed by software, hardware, integrated circuits, firmware, micro-code and the like, operating alone or in combination. Likewise, the processing strategy may include, but is not limited to, multiprocessing, multitasking or parallel processing, for example.

The present disclosure contemplates a computer-readable medium that includes instructions or receives and executes instructions, so that the electronic device connected to the communication network may communicate voice, video, audio, images or any other data over the communication network. The instructions may be implemented with hardware, software and/or firmware, or any combination thereof. Further, the instructions may be transmitted or received over the communication network via the communication interface (which may be provided by the communication unit 111, for example). The communication interface may be a part of the processor or may be a separate component. The communication interface may be created in software or may be a physical connection in hardware. The communication interface may be configured to connect with the communication network, external media, the display, or any other components in the electronic device 100, or combinations thereof.

The computer-readable medium may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause the electronic device to perform any one or more of the methods or operations disclosed herein.

The computer-readable medium may include a solid-state memory such as a memory card or other package that houses one or more non-volatile read-only memories. The computer-readable medium may also be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the present disclosure may be considered to include any one or more of a computer-readable medium or a distribution medium and other equivalents and successor media, in which data or instructions may be stored.

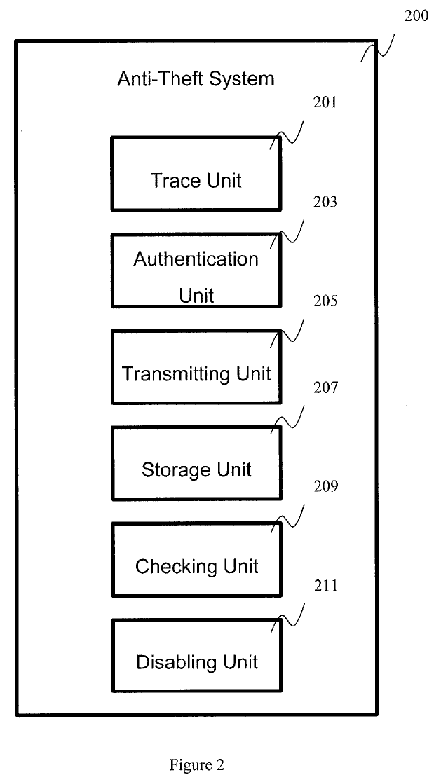

FIG. 2 shows an example illustration of an architecture of an anti-theft system in accordance with an embodiment of the invention. The anti-theft system 200 may be a hardware unit, connected to the bus 113 as shown in FIG. 1, or may be a set of software units, residing in the memory unit 103 and/or executing on the processing unit 101 of FIG. 1, or a combination of hardware and software within an electronic device. It will be understood that the anti-theft system 200 may make use of other devices in an electronic device in which it is embedded, such as the communication unit 111, an input unit 107, an output unit 105, or a peripheral device 115 (e.g., such as a camera or microphone).

As shown in FIG. 2, the anti-theft system may include a trace unit 201, which may be configured to determine trace information to trace a present user of the electronic device. In this context, the trace information may be device information, location information, and/or identification information, for example.

The device information may be device identification, and/or a Subscriber Identity Module (SIM) card International Mobile Subscriber Identity (IMSI), for example.

The location information may be a radio network cell code, a radio network area code, information relating to a base station, information relating to a wireless access point, an Internet Protocol (IP) address, information on a triangulated location address or position, and/or Global Positioning System (GPS) coordinates, for example.

The identification information may be a photograph of the present user, a photograph of the present user's surrounding, a voice recording of the present user, a video recording of the present user, and/or a fingerprint of the present user, for example.

In some embodiments, the trace unit 201 may also be connected to the communication network.

Additionally, the anti-theft system 200 may further include an authentication unit 203, which may be configured to obtain authentication information to determine whether or not the present user of the electronic device is a valid user of the electronic device. In this context, the authentication information may be predefined data of the other user who has been previously determined to be the valid user of the electronic device.

In some embodiments, the authentication unit 203 may prompt the present user for the authentication information.

The anti-theft system 200 may further include a transmitting unit 205, which may be configured to use the communication capabilities of the electronic device (e.g., the communication unit 111, a peripheral device 115, and/or an output unit 105) to send the trace information to another user who had been previously determined to be the valid user of the electronic device 100, if it is determined that the present user is not the valid user of the electronic device.

In some embodiments, the transmitting unit 205 may send the predefined information of the other user, who has been previously determined to be the valid user of the electronic device 100, and the trace information to the other user, who has been previously determined to be the valid user of the electronic device 100, if it is determined that the present user is not a valid user of the electronic device 100.

In some embodiments, the transmitting unit 205 may send the trace information to the other user, who has been previously determined to be the valid user of the electronic device 100, if it is determined that the present user is not the valid user of the electronic device 100, via a communication service. The communication service may be, for example, a Short Message Service (SMS), Electronic Mail (e-mail), Internet Relay Chat (IRC), a BLUETOOTH® short-range wireless network, facsimile (fax), and/or any other wireless or wired network communication service to which the electronic device 100 has access.

In some embodiments, the transmitting unit 205 may send the trace information to the other user who has been previously determined to be the valid user of the electronic device 100, if it is determined that the present user is not the valid user of the electronic device 100, by means that are hidden from the present user.

In some embodiments, the anti-theft system 200 may further include a storage unit 207, which may be configured to store on the electronic device 100 (e.g., in the memory unit 103, or in other non-volatile storage), predefined information of the other user, who has been previously determined to be the valid user of the electronic device 100. The predefined information of the other user, who has been previously determined to be the valid user of the electronic device 100, may include, for example, a text message to send out, a number of times to send out the text message, a time interval between two consecutive transmissions of the text message, at least one phone number to send out a Short Messaging Service (SMS) message to, and at least one e-mail address to send the text message.

In some embodiments, the anti-theft system 200 may further include a checking unit 209, which may be configured to check for an occurrence of a triggering event before determining the trace information. In some embodiments, the anti-theft system 200 may further include a checking unit 209, which may be configured to check for an occurrence of a triggering event before obtaining the authentication information.

In this context, the triggering event may include powering up the electronic device 100, changing of a Subscriber Identity Module (SIM) card of the electronic device and/or accessing confidential data, for example.

In some embodiments, the anti-theft system 200 may further include a disabling unit 211, which may be configured to disable the electronic device 100 and inform the current (perhaps illegitimate) user how to return the electronic device 100 to the other user (who has been previously determined to be a valid user of the electronic device 100).

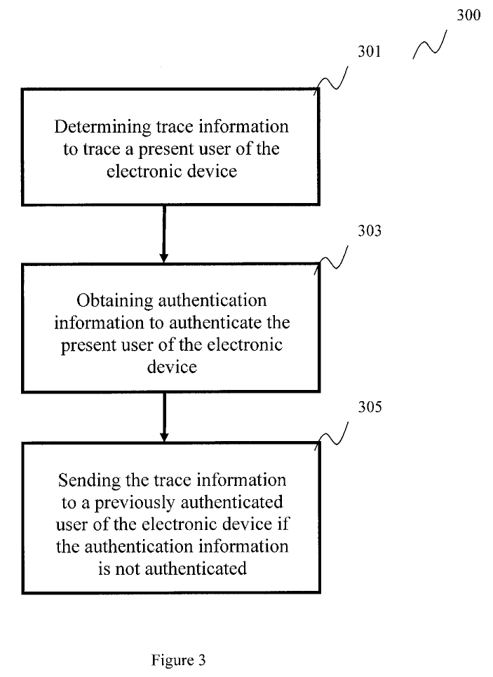

FIG. 3 shows a flow diagram 300 illustrating a method for recovering a lost or stolen electronic device according to an embodiment of the invention.

In step 301, trace information may be determined. The trace information may be used to trace a present user of the electronic device.

In some embodiments, the determination of the trace information may include connecting to a communication network.

Next, in step 303, authentication information may be obtained. The authentication information may be used to determine whether or not the present user of the electronic device is a valid user of the electronic device.

In one embodiment, the obtaining of the authentication information to determine whether or not the present user of the electronic device is the valid user of the electronic device may include prompting the present user for the authentication information.

In step 305, the trace information may be sent to another user, who had been previously determined to be the valid user of the electronic device, if it is determined that the present user is not the valid user of the electronic device.

In some embodiments, the sending of the trace information to the other user who has been previously determined to be the valid user of the electronic device, if it is determined that the present user is not the valid user of the electronic device, may include sending the trace information via a communication service.

In some embodiments, the sending of the trace information to the other user who has been previously determined to be the valid user of the electronic device, if it is determined that the present user is not the valid user of the electronic device, may be hidden from the present user.

In some embodiments, the method may further include storing on the electronic device, a predefined information of the other user, who has been previously determined to be the valid user of the electronic device.

In some embodiments, the method may further include sending the predefined information of the other user, who has been previously determined to be the valid user of the electronic device, and the trace information to the other user, who has been previously determined to be the valid user of the electronic device, if it is determined that the present user is not the valid user of the electronic device.

In some embodiments, the method may further include checking for an occurrence of a triggering event before determining the trace information.

In some embodiments, the method may further include checking for an occurrence of a triggering event before obtaining the authentication information.

In some embodiments, the method may further include disabling the electronic device and informing the user of the manner to return the electronic device to the other user who has been previously determined to be the valid user of the electronic device.

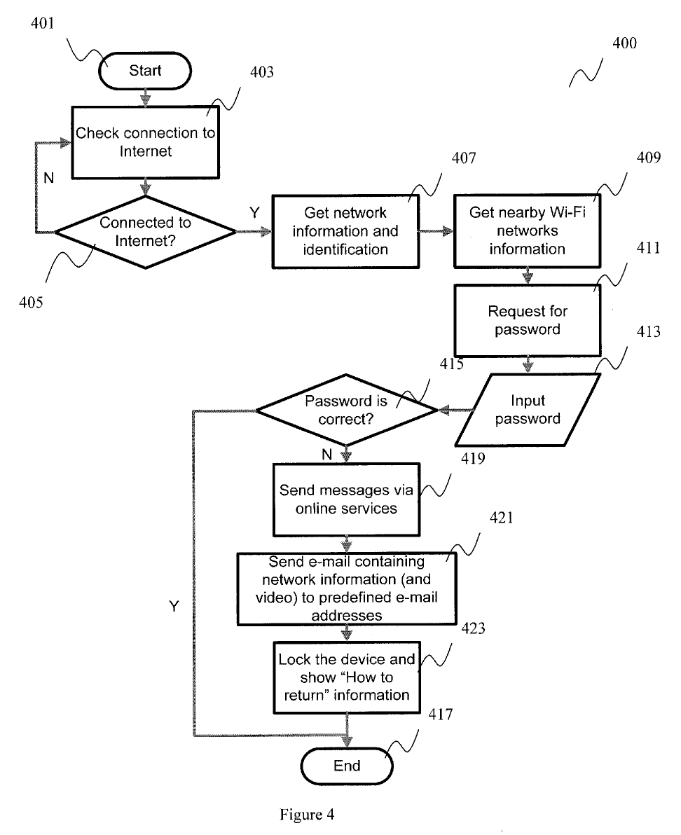

FIG. 4 shows a flow diagram 400 illustrating a first example implementation of the method for recovering a lost or stolen electronic device according to an embodiment of the invention.

In step 401, the electronic device is powered up and the method for recovering a lost or stolen electronic device may be executed. Next, in step 403, the connection to the communication network (e.g., the Internet) may be checked. Following this, in step 405, it is determined whether or not the electronic device is connected to the communication network (e.g., the Internet).

If it is determined in step 405 that the electronic device is not connected to the communication network, the processing proceeds to step 403 where the connection to the communication network may be checked again.

On the other hand, if it is determined in step 405 that the electronic device is connected to the communication network, the processing proceeds to step 407, where information related to the communication network and information relating to the identity of the valid user may be obtained.

In this context, the term identity refers to information which may uniquely point to the valid user of the electronic device. The identity may be, but is not limited to, a name, an identification number (e.g., a National Registration Identity Card (NRIC) number), a SIM card IMSI, an electronic device IMEI or an e-mail address, for example.

Further, the term identification refers to a method by which an electronic device determines whether or not the present user is a valid user. The identity may be, but is not limited to, a log-in method, or a check of the current SIM card IMSI against a list of authorized IMSIs, for example.

Following this, in step 409, the information related to the wireless communication network (e.g., Wi-Fi) may be obtained. Next, in step 411, the present user of the electronic device may be prompted to enter a password.

When the password entered by the present user is received (in step 413), the processing proceeds to step 415, where it is determined whether or not the entered password is the correct password.

If it is determined (in step 415) that the entered password is the correct password, the processing proceeds to step 417, where the method ends.

On the other hand, if it is determined (in step 415) that the entered password is not the correct password, the processing proceeds to step 419, where the method may send an alert message via an available communication service.

Following this, in step 421, the method may further send an e-mail alert message to one or more predefined e-mail address(es), for example. The e-mail alert message may include information relating to the communication network, to which the electronic device has established a communication connection, for example. The e-mail alert message may further include a video of the present user or a video of the present user's surroundings, for example.

Next, in step 423, the method may lock (or freeze) the electronic device. The method may also display a message, which may include information on how the electronic device may be returned to the valid user, for example.

As an illustrative example, a first implementation of one embodiment of the invention may include the following two modules. The first module may be an interface module for the valid user of the electronic device to input and to record the ownership identity and contact information. The second module may be activated each time the electronic device is powered up.

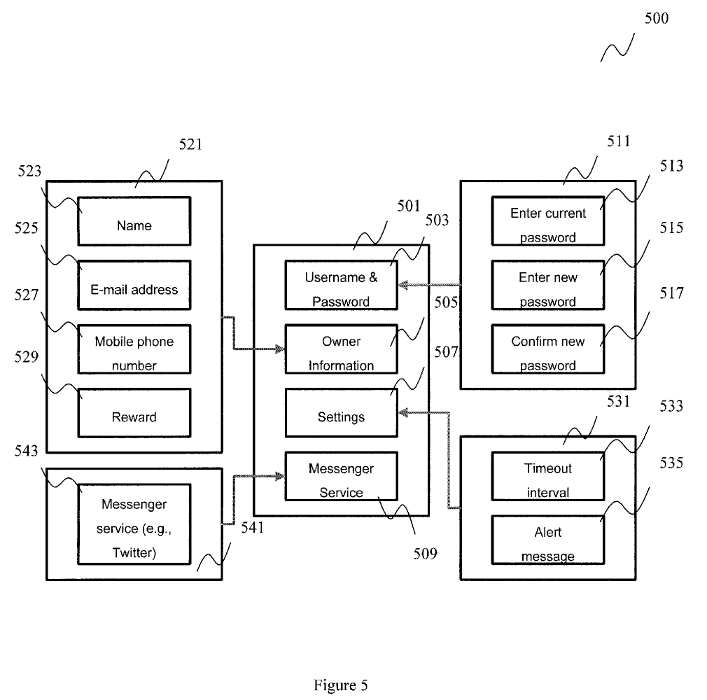

FIG. 5 shows an illustrative example of numerous display windows for the first module of a first implementation of one embodiment of the invention.

In more detail, once the first module is installed and started up, it may request the valid user to create a new password. Once the new password is created, the valid user may be shown a first display window 501, for example as shown in FIG. 5, with the following tabs:

“Username & Password” 503

“Owner Information” 505

“Settings” 507

“Messenger Service” 509

The “Username & Password” tab 503 may be used (by the valid user) to change his password. This password may be required by the first module, whenever the user wishes to access the first module and/or the data stored by the first module, for example.

When the “Username & Password” tab 503 is accessed, a second display window 511, for example, may be displayed. The second display window 511 may include a first input box 513 to enter the current password, a second input box 515 to enter the new password and a third input box 517 to enter the new password for confirmation, for example.

The “Owner Information” tab 505 may be used (by the valid user) to input his name, e-mail address, telephone number and an optional reward amount to a possible finder of the electronic device to return the said electronic device.

When the “Owner Information” tab 505 is accessed, a third display window 521, for example, may be displayed. The third display window 521 may include a first input box 523 to enter the name of the valid user, a second input box 525 to enter the corresponding e-mail address, a third input box 527 to enter the corresponding mobile phone number and a fourth input box 529 to enter the corresponding reward amount, for example.

The “Settings” tab 507 may be used (by the valid user) to set a timeout interval before an alert message is sent out. This timeout interval may be the time interval for the present user to key in the correct password, in order to verify that the present user is indeed the valid user. Further, the alert message may be a communication message, which includes the gathered information which may be useful to help the recovery of the said electronic device, and which may be transmitted to the valid user using the previously recorded owner contact information.

When the “Settings” tab 507 is accessed, a fourth display window 53 1, for example, may be displayed. The fourth display window 531 may include a first input box 533 to enter the timeout interval and a second input box 535 to enter the alert message, for example.

The “Messenger Service” tab 509 may be used (by the valid user) to enable the use a messenger service, such as the TWITTER messenger service, for example, with which the owner may receive alert messages via instant messaging (IM), e-mail, from the web as well as SMS text message (to his mobile phone, for example).

When the “Messenger Service” tab 509 is accessed, a fifth display window 541, for example, may be displayed. The fifth display window 541 may include a first menu box 543 to select or enter the desired messenger service (e.g., Twitter), for example.

Further, the operation of the second module may be described as follows.

When the electronic device is connected to the communication network (via wired or wireless means), such as the Internet, for example, an authentication dialog box may be displayed. The authentication dialog box may request the present user to enter a password. If the present user fails to enter the correct password within a predefined time interval, hidden alert messages (with video capture, for example, and other relevant information) may be sent out to one or more predefined e-mail addresses.

For the electronic device which has a camera, the first implementation of one embodiment of the invention may record videos or pictures using the camera, and then send out alert messages together with other relevant information, such as the IP address, the serial number of the electronic device, the MAC hardware address, and information on nearby wireless networks, for example.

The electronic device may then be automatically “frozen” or disabled to prevent further access. Additionally, the first implementation of one embodiment of the invention may further display information on how to contact the valid user of the electronic device (in order to return the electronic device, for example).

The first implementation may run on an electronic device without a SIM card, for example, a laptop computer or PDA. Further, the first implementation may use a password in order to determine the identity of the present user. Additionally, the first implementation may use a messenger service, such as the ‘TWITTER’ service, for example, in order to send out one or more SMS text alert messages.

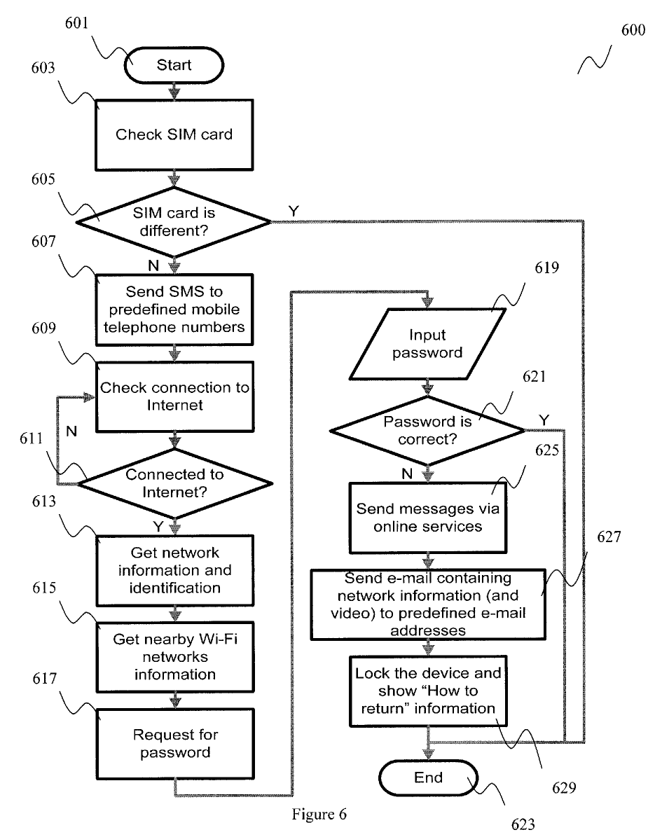

FIG. 6 shows a flow diagram 600 illustrating a second example implementation of the method for recovering a lost or stolen electronic device according to one embodiment of the invention.

In step 601, the electronic device is powered up and the method for recovering a lost or stolen electronic device may be executed. Next, in step 603, the Subscriber Identity Module (SIM) card (or other replaceable identity module—as used herein, a SIM card indicates a Subscriber Identity Module as currently used in certain communications devices, or any similar replaceable identity module) in the electronic device may be checked by the said method. Following which, in step 605, it is determined whether or not the SIM card is a. SIM card which is authorized for use in the electronic device.

If it is determined (in step 605) that the SIM card is a SIM card which is authorized for use in the electronic device, the processing proceeds to step 623, where the said method ends.

However, if it is determined (in step 605) that the SIM card is a SIM card which is not authorized for use in the electronic device, the processing proceeds to step 607, where the said method may send an alert message via Short Messaging Service (SMS) to one or more predefined mobile phone number(s), for example.

Next, in step 609, the connection to the communication network (e.g., the Internet) may be checked by the said method. Following this, in step 611, it is determined whether or not the electronic device is connected to the communication network (e.g., the Internet, a cellular network, or other communication network).

If it is determined in step 611 that the electronic device is not connected to the communication network, the processing proceeds to step 609 where the connection to the communication network may be checked again.

On the other hand, if it is determined in step 611 that the electronic device is connected to the communication network, the processing proceeds to step 613, where information related to the communication network and information relating to the identity of the valid user may be obtained.

Following which, in step 615, the information related to the wireless communication network (e.g., WI-FI) may be obtained. Next, in step 617, the present user of the electronic device may be prompted to enter a password.

When the password entered by the present user is received (in step 619), the processing proceeds to step 621, where it is determined whether or not the entered password is the correct password.

If it is determined (in step 621) that the entered password is the correct password, the processing proceeds to step 623, where the said method ends.

On the other hand, if it is determined (in step 621) that the entered password is not the correct password, the processing proceeds to step 625, where the said method may send an alert message via an available communication service.

Following this, in step 627, the method may further send an e-mail alert message to one or more predefined e-mail address(es), for example. The e-mail alert message may include information relating to the communication network, to which the electronic device has established a communication connection, for example. The e-mail alert message may further include a video of the present user or a video of the present user's surroundings, for example.

Next, in step 629, the method may lock (or disable) the electronic device. The method may also display a message, which may include information on how the electronic device may be returned to the valid user, for example. Following this, the processing proceeds to step 623, where the said method ends.

As another illustrative example, a second implementation of one embodiment of the invention may include the following two modules. The first module may be an interface module for the valid user of the electronic device to input and record ownership identity and contact information. The second module may be activated each time the electronic device is powered up.

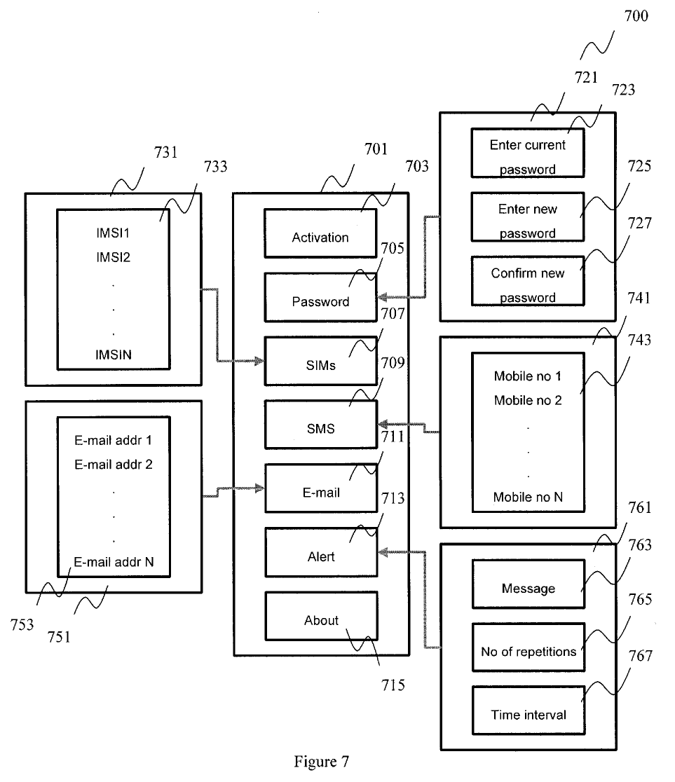

FIG. 7 shows an illustrative example of display windows for the first module of a second implementation of one embodiment of the invention.

In more detail, once the first module is installed and started up, it may request the valid user to create a new password. Once the new password is created, the valid user may be shown a first display window 701, for example as shown in FIG. 7, with the following tabs:

“Activation” 703

“Password” 705

“SIMs” 707

“SMS” 709

“E-mail” 711

“Alert” 713

“About” 715

As a side note, it can be seen that the first module of the second implementation has tabs similar to those of the first module of the first implementation. However, it can also be seen that the first module of the second implementation has more tabs than the first module of the first implementation.

Turning now to the “Activation” tab 703, this tab may be used (by the valid user) to key in an activation code, in order to be able to use the second implementation. This activation process may be a one time activity and may be used for software licensing purposes. Further, this activation process may be used to confirm that the valid user has a legal copy of the first module and that any information gathered by the first module may be part of a legitimate anti-theft process.

The “Password” tab 705 may be used (by the valid user) to change his password. This password may be required by the first module, whenever the user wishes to access the first module and/or the data stored by the first module, for example. This password may also be used when the user wants to uninstall the first module, for example, in order to upgrade to a newer version of the first module, for example.

When the “Password” tab 705 is accessed, a second display window 721, for example, may be displayed. The second display window 721 may include a first input box 723 to enter the current password, a second input box 725 to enter the new password and a third input box 727 to enter the new password for confirmation, for example.

The “SIMs” tab 707 may be used (by the valid user) to input more than one SIM card's IMSI (or other identification information), for example. The said IMSIs may be used by the second module (which will be described in more detail later) to verify that a SIM card is authorized for use on the electronic device. Should the SIM card used be found to be one which is not authorized for use on the electronic device, alert messages may be sent out accordingly.

When the “SIMs” tab 707 is accessed, a third display window 731, for example, may be displayed. The third display window 731 may include a first input box 733 to enter a list of IMSIs corresponding to the SIM cards authorized for use on the electronic device, for example.

The “SMS” tab 709 may be used (by the valid user) to input more than one mobile phone number. These mobile phone numbers may be used by the second module to send out alert messages to, when the second module determines that the electronic device is lost or that the electronic device is being used by an illegitimate user, for example.

When the “SMS” tab 709 is accessed, a fourth display window 741, for example, may be displayed. The fourth display window 741 may include a first input box 743 to enter a list of mobile phone numbers to send out alert messages to, for example.

The “E-mail” tab 711 may be used (by the valid user) to input more than one e-mail address. These e-mail addresses may be used by the second module to send out alert messages to, when the second module determines that the electronic device is lost or that the electronic device is being used by an illegitimate user, for example.

When the “E-mail” tab 711 is accessed, a fifth display window 751, for example, may be displayed. The fifth display window 751 may include a first input box 753 to enter a list of e-mail addresses to send out alert messages to, for example.

The “Alert” tab 713 may be used (by the valid user) to do any one of the following:

1. To input a user defined alert message,

2. To define a number of times to send out the alert message, and

3. To define a time interval between two consecutive transmissions of the alert messages.

When the “Alert” tab 713 is accessed, a sixth display window 761, for example, may be displayed. The sixth display window 761 may include a first input box 763 to enter the alert message, a second input box 765 to enter the number of times to send out the alert message and a third input box 767 to enter the time interval between two consecutive transmissions of the alert messages, for example.

The “About” tab 715 may be used (by the valid user) to determine the version of the first module and/or the second module, which is/are presently installed on the electronic device, for example. Additionally, the “About” tab may also be used (by the valid user) to determine the status and/or the settings of the first module and/or the second module, for example. The ‘About’ tab 715 may further be used to display copyrights and hyperlinks to the corporate website, for example.

Turning now to the second module, once the electronic device is powered up, the second module first determines whether or not the current SIM's IMSI matches one of the IMSIs stored by the valid user. If the iStealth module first determines that the current SIM's IMSI does not match one of the IMSIs stored by the valid user, the second module may shut itself down. Otherwise, the second module may gather the following information and then send out alert messages:

1. From the right owner's stored information:
a. the defined alert message to send out
b. the number of times to send out alert messages
c. the time interval between two consecutive transmissions of the alert messages
d. the list of mobile phone numbers to send out SMS alert messages
e. the list of e-mail addresses to send out e-mail alert messages

2. From the electronic device and the communication network which the electronic device may be connected to (e.g., device information and location information):
a. the electronic device identity (ID), e.g., IMEI or MAC address
b. the current SIM IMSI
c. the radio network cell code (or identifier) and/or the radio network area code
d. the GPS coordinates and/or the triangulated location address (or position) and/or the IP address

3. From the present (illegitimate) user identity information:
a. a photograph of the present user or of the present user's surrounding
b. a voice recording of the present user
c. a video recording of the present user
d. a fingerprint of the present user

Unlike the first implementation, the second implementation may run on an electronic device with a SIM card, for example, a mobile phone, “smart phone”, or other mobile communication device that uses a SIM card or similar replaceable identity module. The second implementation may determine whether or not a SIM card is authorized for use on the electronic device. Should the SIM card used be found to be one which is not authorized for use on the electronic device, the second implementation may then determine the identity of the present user by using a password check. Should the present user be found not to be the valid user of the electronic device, for example, the second implementation may send out one or more e-mail and/or SMS text alert messages accordingly.

Alternatively, the operation of the respective first and second modules of both the first and second implementations may also be described as follows.

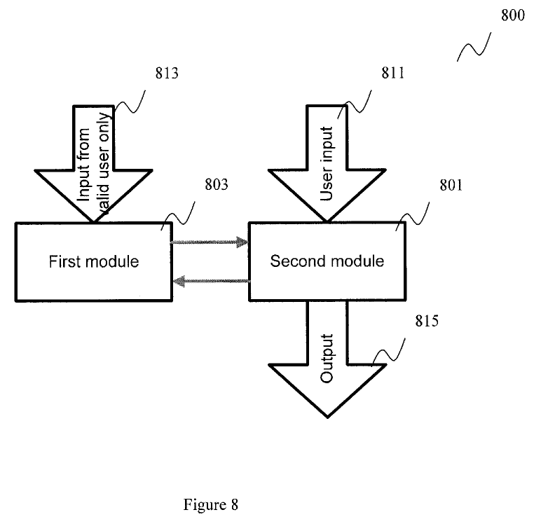

FIG. 8 shows an illustrative example of the operation of the respective first and second modules of the first and second implementations of one embodiment of the invention.

A determination of whether or not the present user is a valid user is first carried out. In this context, the second module 801 receives a user input 811, such as a password check, for example, in order to determine whether or not the present user is a valid user.

If it is determined that the present user is a valid user, then the valid user may be allowed to access the first module 803, in order to provide input 813 into the first module 803, for example. The input 813 may be used to add information to or to change the existing information in the first module 803. As mentioned earlier, the information may include information on the valid user's identity and/or other information on user settings, for example.

On the other hand, if it is determined that the present user is not a valid user, then the second module 801 may obtain the information stored in the first module 803, and provide the output 815 accordingly. The output 815 may include one or more alert messages which may be sent out according to the information stored in the first module 803 and/or one or more control signals, which may be used to disable or freeze the electronic device, for example.

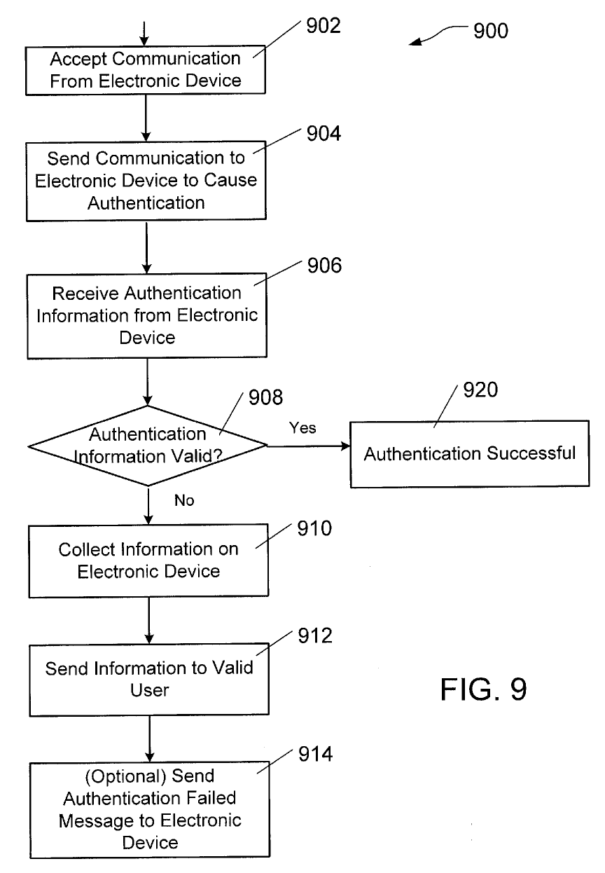

Referring now to FIG. 9, an alternative embodiment of the invention is described, in which authentication, determining the trace information, and sending the trace information are all handled by a server operated by a service provider. This embodiment may be used, for example, with portable electronic devices (such as some cell phones and music players) when there is limited ability to install software for handling collection of information and authentication.

According to the method 900, in 902, a server operated by a service provider accepts a connection or communication from a electronic device. In 904, the server sends a message to the electronic device that will cause the electronic device to collect authentication information. This message may be, for example, an HTML Web page, a program that can be executed in a Web browser, or other data or instructions that cause the electronic device to request authentication information from the user of the electronic device. For example, the message may cause the electronic device to display a keypad on its touch-screen (assuming that the portable device is so equipped), on which the user of the portable device will be required to enter an authentication code.

Next, in 906, the server receives the authentication information from the electronic device, and in 908 the server determines whether the authentication information is valid. This may be achieved, for example, by comparing the authentication information to authentication information that has been stored by the service provider. If the authentication information was valid, then at 920, the authentication process ends, and the device is permitted to continue with the original task that triggered the authentication procedure. Optionally, in some embodiments, the server may send a message to the electronic device indicating that Authentication was successful.

If the authentication information is not valid, then at 910, the server collects recovery information from the electronic device. For example, the current IP address of the electronic device may be collected from the communications packets that have been sent to the server by the electronic device. Alternatively, if the electronic device is configured to do so, further information relating to the current location of the electronic device or to the current user of the electronic device may be requested by the service provider and sent by the electronic device.

At 912, having collected recovery information concerning the electronic device and/or its present user, the service provider sends the information to the other user, who has been previously determined to be the valid user of the electronic device. This information may be of use in recovering the lost or stolen electronic device.

Optionally, in some embodiments, at 914 the service provider may send a communication to the electronic device that causes the electronic device to display information on returning the electronic device, or in some embodiments (where this option is supported), that disables the electronic device.

The method 900 may be initiated by a number of events. For example, if a user of the electronic device starts a Web browser, the browser can be pre-set to connect to the server. Alternatively, “traps” may be set on the electronic device, by adding icons or other selection items to the electronic device that have names indicating that they have contents that would be desirable to a thief (e.g., “bank accounts”, “credit card numbers”), and that are pre-programmed to cause the electronic device to connect to the server. Alternatively, depending on the capabilities of the electronic device, connection to the server (and starting the method 900) may be triggered by other events, such as attempting to make a telephone call, or by the kinds of triggering events described with reference to other embodiments.

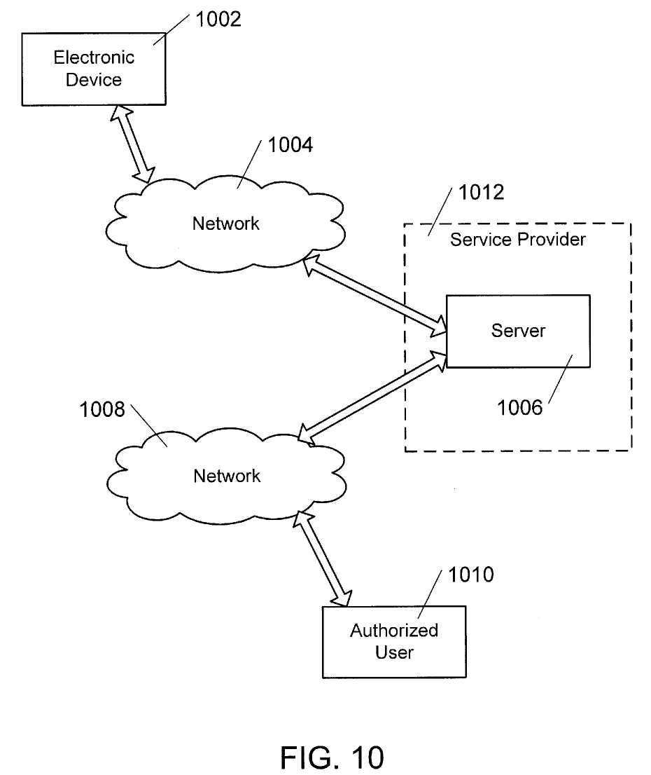

Referring now to FIG. 10, am overall system in which the server running the method of FIG. 9 is described. In the system 1000, An electronic device 1002, which may be, for example, a portable electronic device such as a cellular telephone, is able to communicate with a server 1006 via a network 1004. The network 1004 may be a wireless network, the Internet, a cellular network, or any other communications network capable of transferring data between the electronic device 1002 and the server 1006. The server 1006 may be operated by a service provider 1012, and may operate the method described above, with reference to FIG. 9.

The server 1006 may communicate via a network 1008 (which may be the same network as the network 1004, or may be a different communications network, such as a telephone network) to an owner or authorized user 1010 of the electronic device 1002, if it is determined (through an authentication method as described above) that the electronic device 1002 has been lost or stolen.

Generally, embodiments of the present invention may involve a service provider (such as an anti-theft service provider) as well, rather than just the valid user of the electronic device. For example, in one embodiment, the valid user may install the anti-theft software on the electronic device. The electronic device may communicate with the service provider, and the service provider may then communicate with the valid user, in the event that the electronic device is lost or stolen.

Embodiments of the invention may provide an easy-to-use means for recovering a lost or stolen electronic device. Embodiments of the inventions may also secure the confidential data of a legitimate user, should the electronic device be lost or stolen.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for recovering a lost or stolen electronic device, the method comprising
determining a trace information to trace a present user of the electronic device,
obtaining an authentication information to determine whether or not the present user of the electronic device is a valid user of the electronic device, and
sending the trace information to an other user who has been previously determined to be the valid user of the electronic device, if it is determined that the present user is not the valid user of the electronic device.

2. The method of claim 1, wherein obtaining an authentication information comprises sending a message from a server to the electronic device to cause the electronic device to obtain authentication information from the present user.

3. The method of claim 1, wherein sending the trace information comprises sending the trace information from a server to the other user.

4. The method of claim 1, wherein determining a trace information comprises determining a trace information if it is determined that the present user is not the valid user of the electronic device.

5. The method of claim 4, wherein determining a trace information comprises determining a trace information on a server that has communicated with the electronic device.

6. The method of claim 5, wherein determining a trace information comprises capturing an IP address of the electronic device.

7. The method of claim 1, further comprising
collecting and storing a predefined information of the other user.

8. The method of claim 7, further comprising sending a message based on the predefined information of the other user and the trace information to the other user if it is determined that the present user is not the valid user of the electronic device.

9. The method of claim 7, wherein the predefined information of the other user comprises one or more of:
a text message to be sent;
a number of times to send the text message;
a time interval between two consecutive transmissions of the text message;
at least one phone number to which to send a Short Messaging Service (SMS) message; and
at least one e-mail address to which to send the text message.

10. The method of claim 1, further comprising starting the method on occurrence of a triggering event.

11. The method of claim 10, wherein the triggering event comprises the present user of the electronic device selecting a selection item on the electronic device.

12. The method of claim 11, wherein the selection item comprises a trap selection item, labeled to be attractive to a thief.

13. The method of claim 10, wherein the triggering event comprises starting a Web browser on the electronic device.

14. The method of claim 10, wherein the triggering event comprises powering up the electronic device.

15. The method of claim 10, wherein the triggering event comprises determining that a Subscriber Identity Module (SIM) card of the electronic device has been changed.

16. The method of claim 10 wherein the triggering event comprises attempting to access confidential data.

17. The method of claim 1, wherein determining the trace information comprises connecting to a communication network.

18. The method of claim 1, wherein the trace information comprises one or more of:
a device information;
a location information, and
an identification information.

19. The method of claim 18, wherein the device information comprises one or more of:
a device identification; and
a Subscriber Identity Module (SIM) card International Mobile Subscriber Identity (IMSI).

20. The method of claim 18, wherein the location information comprises one or more of:
a radio network cell code;
a radio network area code;
information relating to a base station;
information relating to a wireless access point;
an Internet Protocol (IP) address;
information on a triangulated location address or position; and
Global Positioning System (GPS) coordinates.

21. The method of claim 18, wherein the identification information comprises one or more of:
a photograph of the present user;
a photograph of the present user's surrounding;
a voice recording of the present user;
a video recording of the present user; and
a fingerprint of the present user.

22. The method of claim 1, wherein obtaining the authentication information to determine whether or not the present user of the electronic device is the valid user of the electronic device comprises prompting the present user for the authentication information.

23. The method of claim 1, wherein sending the trace information to the other user if it is determined that the present user is not the valid user of the electronic device comprises sending the trace information via a communication service.

24. The method of claim 23, wherein the communication service comprises one or more of:
Short Message Service (SMS);
Electronic Mail (e-mail);
Internet Relay Chat (IRC);
a short-range wireless network service;
an automated voice message;
a wireless network communication service;
a wired network communication service;
a cellular network communication service; and
facsimile (fax).

25. The method of claim 1, wherein the authentication information comprises a predefined data of the other user.

26. The method of claim 1, wherein sending the trace information to the other user if it is determined that the present user is not the valid user of the electronic device further comprises hiding from the present user that the trace information is sent.

27. The method of claim 1, further comprising disabling the electronic device and informing the present user of the manner to return the electronic device to the other user.

28. A system for recovering a lost or stolen electronic device, the system comprising
a trace unit configured to determine a trace information to trace a present user of the electronic device,
an authentication unit configured to obtain an authentication information to determine whether or not the present user of the electronic device is a valid user of the electronic device, and
a transmitting unit configured to send the trace information to an other user who has been previously determined to be the valid user of the electronic device, if it is determined that the present user is not the valid user of the electronic device.

29. The system of claim 28, further comprising a checking unit configured to check for an occurrence of a triggering event.

30. The system of claim 29, wherein the triggering event comprises powering up the electronic device.

31. The system of claim 29, wherein the triggering event comprises determining that a Subscriber Identity Module (SIM) card of the electronic device has been changed.

32. The system of claim 29, wherein the triggering event comprises attempting to access confidential data.

33. The system claim 28, wherein the trace unit is connected to a communication network.

34. The system of claim 28, wherein the trace information comprises one or more of:
a device information;
a location information; and
an identification information.

35. The system of claim 34, wherein the location information comprises one or more of:
a radio network cell code;
a radio network area code;
information relating to a base station;
information relating to a wireless access point;
an Internet Protocol (IP) address;
information on a triangulated location address or position; and
Global Positioning System (GPS) coordinates.

36. The system of claim 34, wherein the identification information comprises one or more of:
a photograph of the present user;
a photograph of the present user's surrounding;
a voice recording of the present user;
a video recording of the present user; and
a fingerprint of the present user.

37. The system of claims 28, further comprising a disabling unit configured to disable the electronic device and informing the user of the manner to return the electronic device to the other user.

38. A method of recovering a lost or stolen electronic device, comprising:
receiving a communication from an electronic device to initiate an authentication process;
sending a communication to the electronic device to cause the electronic device to collect an authentication information;
receiving the authentication information from the electronic device;
determining whether the authentication information is valid;
collecting recovery information on the electronic device if the authentication information was not valid; and
sending the recovery information to a predetermined valid user of the electronic device if the authentication information was not valid.

39. The method of claim 38, further comprising sending a message that the authentication has failed to the electronic device if the authentication was not valid.

40. The method of claim 39, wherein sending a message that the authentication has failed comprises sending a message to disable the electronic device.

41. The method of claim 39, wherein sending a message that the authentication has failed comprises sending a message to display information on the electronic device relating to returning the electronic device.

42. The method of claim 38, wherein collecting recovery information comprises collecting an IP address of the electronic device.

43. A system for recovering a lost or stolen electronic device, comprising:
a server configured to communicate with an electronic device over a first network and to communicate with a predetermined valid user of the electronic device over a second network, the server further configured to:
receive a communication from an electronic device to initiate an authentication process;
send a communication to the electronic device to cause the electronic device to collect an authentication information;
receive the authentication information from the electronic device;
determine whether the authentication information is valid;
collect recovery information on the electronic device if the authentication information was not valid; and
send the recovery information to the predetermined valid user of the electronic device if the authentication information was not valid.

44. The system of claim 43, wherein the first network and the second network are the same communications network.

45. The system of claim 43, wherein the system is configured to collect recovery information on the electronic device by determining an IP address of the electronic device.
